(19) United States
(12) Patent Application Publication
(10) Pub. No.: US 2009/0269001 A1
(43) Pub. Date: Oct. 29, 2009

(54) Apparatus and Method for Detecting Intrusion by Using Fiber Bragg Grating Sensor

(76) Inventor: Geumsuk Lee, Chungcheongnam-do (KR)

Correspondence Address: John W. Renner;Renner, Otto, Boisselle & Sklar, 1621 Euclid Avenue, 19th Floor, Cleveland, OH, 44115, US

(21) Appl. No.: 12/083,134

(22) PCT Filed: Oct. 10, 2006
(86) PCT No.: PCT/KR2006/004074

§ 371 Date: Apr. 3, 2008

(30) Foreign Application Priority Data
Oct. 10, 2005 (KR) 1020050094696
Sep. 12, 2006 (KR) 20060087910

(51) Int. Cl. G02B 6/00

(52) U.S. Cl. 385/12

(57) ABSTRACT

Disclosed are an apparatus and a method for detecting intrusion by using fiber Bragg grating (FBG) sensors. the apparatus includes a measurement system, an optical fiber for transmitting and detecting optical signals, and a plurality of FBG sensors installed in intrusion detection areas together with the optical fiber and representing reflective wavelengths different from each other. The method includes the steps of installing the optical fiber and the FBG sensors in predetermined intrusion areas, continuously measuring wavelength variation or wavelength intensity of the optical fiber by using the measurement system, and comparing the measured wavelength variation or measured wavelength intensity of the optical fiber with a reference value, thereby determining intrusion of an intruder. Since the apparatus includes the optical switch and the optical distributor, the system establishment cost is reduced, the intrusion detection area is enlarged, and plural independent intrusion detection areas are formed.

### TECHNICAL FIELD

The present invention relates to an apparatus and a method for detecting intrusion by using a fiber Bragg grating (FBG) sensor. More particularly, the present intentional relates to an apparatus and a method for detecting intrusion by using a fiber Bragg grating (FBG) sensor, in which the FBG sensor or an FBG strain sensor, and an FBG vibration sensor are attached to a fence, such as wire-entanglements, so as to detect intrusion based on physical pressure applied to the fence and a cut-off state of an optical transmission line.

### BACKGROUND ART

In general, an intrinsic wavelength of a fiber Bragg grating (FBG) sensor is changed according to physical pressure applied to the FBG sensor. If an optical transmission path is shortened, an intensity of a reflective wavelength of the FBG sensor is reduced. Accordingly, it is possible to precisely detect intruders and the intrusion position based on physical pressure applied to a fence and a cut-off state of an optical transmission line by detecting wavelength variation and light-quantity variation of FBG sensors attached to the fence.

Conventionally, an optical time domain reflectometer (OTDR) scheme is used to detect intruders and the intrusion position. According to the OTDR scheme, light irradiated from an OTDR passes through optical fibers attached to a fence, and the light is scattered if there is micro-bending or cut-off of the optical fibers. In this case, the light is reflected toward the OTDR. The OTDR scheme detects intruders and the intrusion position by measuring arriving time of the light to the OTDR. At this time, the OTDR performs computation proportionally to the length of the optical fibers attached to the fence and analyzes the state of the optical fibers. However, it takes 2 to 3 seconds to analyze signals generated from the optical fibers attached to the fence having the length of 200 mm due to the great amount of data. In addition, the optical fibers must be arranged over the whole area of the fence in the form of a net in order to detect intruders and the intrusion position.

Furthermore, in order to facilitate micro-bending of the optical fibers, the optical fibers must cross each other while being fixed by means of a rigid member. However, since the rigid member is provided in addition to the optical fibers, the weight and volume of an intrusion protection system may increase, so that the intrusion protection system frequently malfunctions when it is influenced by rain, wind and snow, and erroneously raises an alarm due to tare thereof or when it is affected by animals.

In addition, the ODTR system is very complicated and expensive, and does not employ an optical distributor, such as an optical coupler, due to the unique measurement scheme thereof, so the ODTR system must detect the fence having the length of 200 m by using one strand of optical fiber. Thus, if cut-off of the optical fiber occurs at a location remote from the front part of the fence by 20 m, the ODTR system cannot detect intruders who break through the remaining part (180 m) of the fence.

### DISCLOSURE

### Technical Problem

The present invention has been made to solve the above problem occurring in the prior art, and an object of the present invention is to provide an apparatus and a method for detecting intrusion by using a fiber Bragg grating (FBG) sensor, which can reduce a system establishment cost while forming an intrusion detection area with respect to a plurality of independent fences.

Another object of the present invention is to provide an apparatus and a method for detecting intrusion by using a fiber Bragg grating (FBG) sensor, which can reduce an influence derived from cut-off of optical fibers, and can prevent malfunction of an intrusion protection system caused by rain or wind by minimizing the size and lightening the weight of optical fibers.

Still another object of the present invention is to provide an apparatus and a method for detecting intrusion by using a fiber Bragg grating (FBG) sensor, which can enlarge an intrusion detection area by about 10 times or more using an optical switch.

Still yet another object of the present invention is to provide an apparatus and a method for detecting intrusion by using a fiber Bragg grating (FBG) sensor, which can facilitate installation and repair and maintenance work for an intrusion detection system.

### Technical Solution

In order to accomplish the above objects, according to one aspect of the present invention, there is provided an apparatus for detecting intrusion, the apparatus comprising: a measurement system; an optical fiber for transmitting and detecting optical signals; and a plurality of fiber Bragg grating (FBG) sensors installed in intrusion detection areas together with the optical fiber and representing reflective wavelengths different from each other.

According to another aspect of the present invention, there is provided a method for detection intrusion by using fiber Bragg grating (FBG) sensors, the method comprising the steps of: installing an optical fiber and the FBG sensors in predetermined intrusion areas; continuously measuring wavelength variation or wavelength intensity of the optical fiber by using a measurement system; and comparing the measured wavelength variation or measured wavelength intensity of the optical fiber with a reference value, thereby determining intrusion of an intruder.

According to still another aspect of the present invention, there is provided a method for detection intrusion by using fiber Bragg grating (FBG) sensors, the method comprising the steps of: installing an optical fiber and the FBG sensors in predetermined intrusion areas; continuously measuring a number of the FBG sensors by using a measurement system; and comparing the measured number of the FBG sensors with a reference value, thereby determining intrusion of an intruder.

### DESCRIPTION OF THE DRAWINGS

The foregoing and other objects, features and advantages of the present invention will become more apparent from the following detailed description when taken in conjunction with the accompanying drawings in which:

FIG. 1 is a view illustrating an intrusion detection apparatus using a fiber Bragg grating (FBG) sensor according to the present invention;

FIG. 2 is a view illustrating wavelengths of fiber Bragg grating (FBG) sensors transmitted to a measurement system when the FBG sensors have the same reflective characteristics;

FIG. 3 is a view illustrating wavelengths of fiber Bragg grating (FBG) sensors transmitted to a measurement system when the FBG sensors having low reflectivity are installed adjacent to the measurement system and the FBG sensors having high reflectivity are installed remote from the measurement system; and

FIG. 4 is a view illustrating an installation method for optical fibers according to the present invention.

### BEST MODE

Hereinafter, an apparatus for detecting intrusion by using fiber Bragg grating (FBG) sensors according to the preferred embodiment of the present invention will be described with reference to the accompanying drawings.

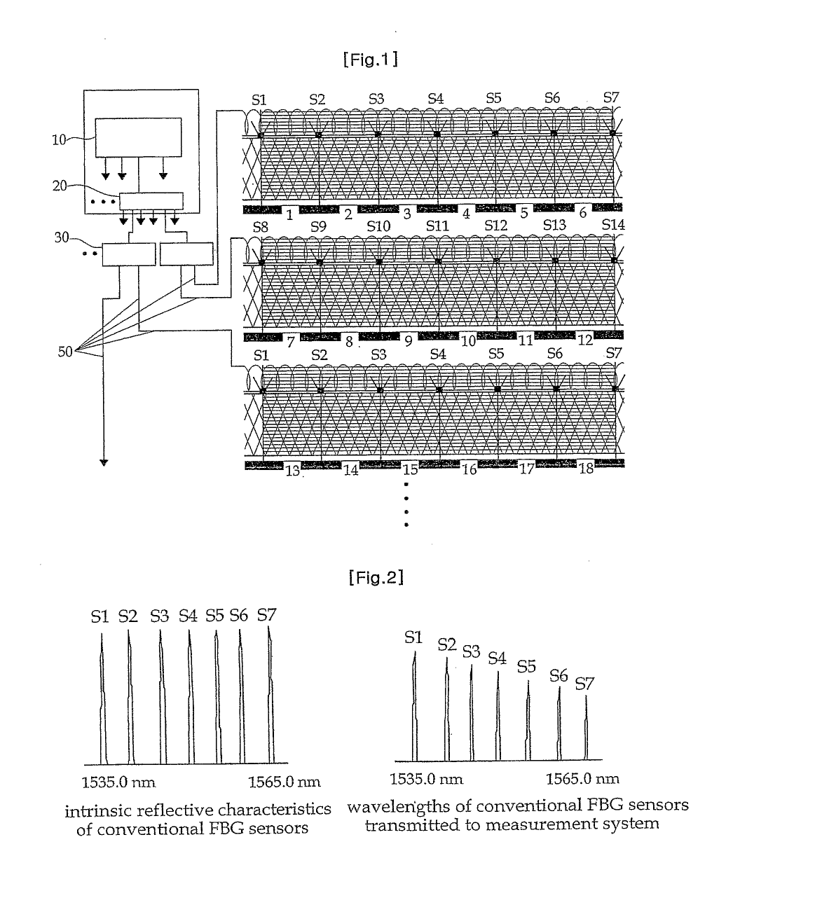

As shown in FIG. 1, the intrusion detection apparatus using FBG sensor according to the present invention mainly includes a measurement system 10, optical fibers 50 connected to the measurement system 10 so as to transmit and detect optical signals, and FBG sensors S1 to S14 installed in the intrusion detection area together with the optical fibers and having reflective wavelengths different from each other.

In addition, an optical distributor 30 is provided between the measurement system 10 and the FBG sensors so as to form intrusion detection areas having different optical transmission lines. That is, the wavelength variation and the wavelength intensity of the intrusion detection area can be detected by dividing the intrusion detection area into at least two intrusion detection areas by using the optical distributor 30.

Furthermore, an optical switch 20 is provided between the measurement system 10 and the FBG sensors so as to form at least one independent intrusion detection channel. That is, it is possible to use FBG sensors having reflective wavelengths equal to those of other channels, or to form an independent intrusion detection area. In other words, it is possible to select an intrusion detection area from among plural intrusion detection areas by using the optical switch 20.

Hereinafter, an installation method for the FBG sensors will be described.

First, the FBG sensors S1 to S14 having reflective wavelengths different from each other are installed on at least one intrusion detection area of a fence. Preferably, the FBG sensors S1 to S14 are installed on columns of the fence. Since physical pressure is applied to the columns of the fence when the intruder makes contact with the fence, the FBG sensors can precisely detect the physical pressure when they area installed on the columns of the fence.

The FBG sensors are connected to each other through single mode optical fibers 50. Preferably, the FBG sensors are installed on the fence while being connected to each other by means of the optical fibers in the form of a zigzag pattern. At this time, an interval between the optical fibers is preferably set within 15 cm such that the intruder does not pass through the fence without cutting off the optical fibers. More preferably, the optical fibers are integrally fixed with the fence by means of coupling members aligned at a predetermined interval. In this case, when the intruder breaks through the fence, such as wire-entanglements, the optical fibers are cut off, so that the intrusion position can be detected. In addition, optical fiber fabricated in the form of a net can be used in order to detect intrusion.

When the FBG sensors are installed on the fence, the optical distributor 30, such as the optical coupler, is installed at a front portion of the FBG sensors so as to provide at least one intrusion detection area. The optical distributor 30 divides the intrusion detection area into several areas so as to reduce the non-detection area when the optical fibers are cut off. Even if the intrusion detection area is divided into several areas, the FBG sensors must have reflective characteristics different from each other.

The optical switch 20 can be installed between the measurement system 10 and the optical distributor 30 in order to provide at least one independent intrusion detection area. At this time, the number of output terminals of the optical switch 20 corresponds to the number of the independent intrusion detection areas. In this case, the FBG sensors having the same reflective characteristics can be installed in the independent intrusion detection areas, respectively, so that the system establishment cost can be reduced.

In general, most measurement systems employing the FBG sensors irradiate broadband light and read wavelengths of the light reflected from the FBR sensors in order to measure wavelength variation. At this time, since the FBG sensors adjacent to the measurement system represent intrinsic attenuation loss and contact loss of optical fibers different from those of the FBG sensors remote from the measurement system due to the difference of light transmission lines therebetween, if the FBR sensors having the same reflectivity are installed in the intrusion detection areas, reliability of the measurement system may be degraded. If wavelength intensities of the light reflected toward the measurement system are different from each other beyond a predetermined range, the measurement system does not precisely measure the wavelength variation.

Therefore, preferably, the FBG sensors having low reflectivity are installed adjacent to the measurement system, and the FBG sensors having high reflectivity are installed remote from the measurement system. For instance, if five FBG sensors S1 to S5 are sequentially provided under the condition that the attenuation loss between adjacent FBG sensors is about 10%, the first FBG sensor S1 preferably has reflectivity of 50%, the second FBG sensor S2 preferably has reflectivity of 60%, the third FBG sensor S3 preferably has reflectivity of 70%, the fourth FBG sensor S4 preferably has reflectivity of 80%, and the fifth FBG sensor S5 preferably has reflectivity of 90%. In this case, the wavelengths of the light reflected toward the measurement system have the same intensity so that the measurement system can measure the wavelength variation.

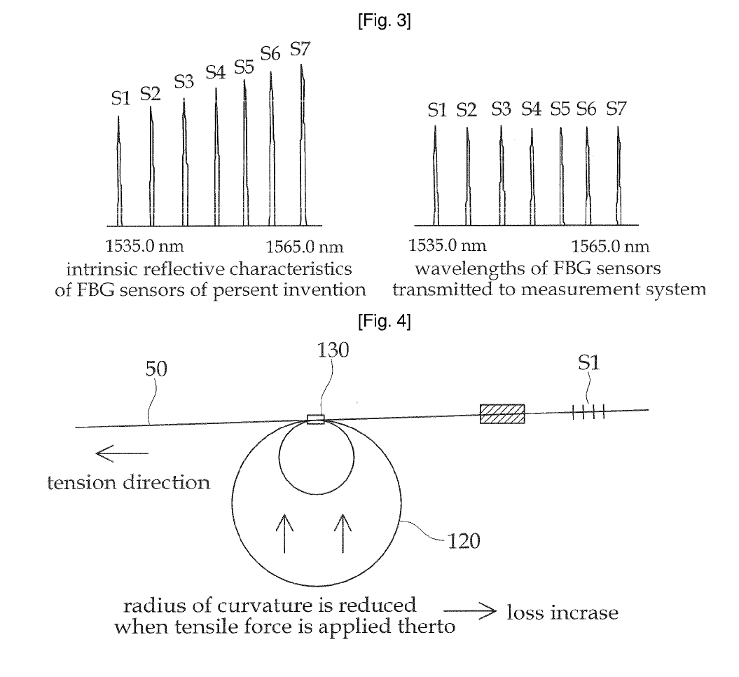

FIG. 2 is a view illustrating wavelengths of the FBG sensors transmitted to the measurement system when the FBG sensors have the same reflective characteristics, and FIG. 3 is a view illustrating wavelengths of the FBG sensors transmitted to the measurement system when the FBG sensors having low reflectivity are installed adjacent to the measurement system and the FBG sensors having high reflectivity are installed remote from the measurement system.

As shown in FIG. 2, if the FBG sensors having the same reflectivity are installed while being spaced apart from each other, wavelength variation and wavelength intensity of the light transmitted to the measurement system 10 are different from each other. That is, the wavelengths of the FBG sensors are gradually decreased proportionally to the distance relative to the measurement system 10.

In order to solve this problem, the FBG sensors having low reflectivity are preferably installed adjacent to the measurement system 10, and the FBG sensors having high reflectivity are preferably installed remote from the measurement system 10. In this case, as shown in FIG. 3, the light reflected from the FBG sensors toward the measurement system 10 represents the same wavelength variation and wavelength intensity.

If intensity of the reflective wavelength of one sensor is different from that of the other sensor by −10 dB (90%) or more, the measurement system employing the FBG sensors does not detect the wavelength of the light having weak intensity.

A space formed between the FBG sensors may serve as an intrusion detection area. Preferably, the space has a length of about 5 m. However, the present invention does not limit the length of the space.

When the sensors are attached to the fence, the position of the sensors may be changed depending on the type of the sensors. First, FBG sensors used for detecting the intrusion position can be attached to various positions in the fence. Second, vibration sensors employing the FBG sensors to detect the intrusion position and vibration of the fence can be installed on upper portions of columns of the fence which represent great vibration variation. Third, strain sensors employing the FBG sensors are preferably installed at lower portions of columns of the fence because the lower portions of the column represent great deformation when pressure is applied to the fence.

Hereinafter, the method for detecting intrusion will be described. First, when an intruder goes over the fence, the wavelength of the FBG sensors installed in the intrusion detection areas is changed due to the weight of the intruder. The changed wavelength of the FBG sensors is transmitted to the measurement system so that the intrusion protection system generates an alarm. In contrast, if the intruder breaks through the fence, intrinsic reflective wavelengths of the FBG sensors installed rearward of the cut-off area are not transmitted to the measurement system. Thus, the cut-off area can be detected by using the above feature. For instance, on the assumption that five FBG sensors S1 to S5 are sequentially installed in the intrusion detection area, if the cut-off occurs between the third FBG sensor S3 and the fourth FBG sensor S4, the measurement system may detect the intrinsic reflective wavelengths of the first to third FBG sensors S1 to S3, but the intrinsic reflective wavelengths of the fourth and fifth FBG sensors S4 and S5 installed rearward of the cut-off area are not detected. Thus, it can be recognized that intrusion occurs between the third FBG sensor S3 and the fourth FBG sensor S4.

Another method is to detect micro-bending of optical fibers when the intruder makes contact with the optical fibers, attachments or underground equipment buried below the fence. In this case, the FBG sensors installed rearward of the micro-bending area represent reflective wavelengths having intensity reduced proportional to the degree of micro-bending. If the intensity of the reflective wavelength is reduced beyond a predetermined range, the intrusion protection system raises an alarm.

The measurement system employing the FBG sensors can be cooperated with various sensors representing the reflective wavelength characteristics of the FBG sensors, so that the intrusion inspection, safety analysis for a structure, fire detection, water level detection, ground pressure detection and the variation detection can be achieved by using only one system and one optical fiber.

Hereinafter, the method for detecting intrusion by using the FBG sensors according to the present invention will be briefly described.

(a) Optical fibers and FBG sensors are installed in predetermined intrusion areas.

(b) The measurement system continuously measures the wavelength variation and wavelength intensity of optical fibers, and the number of the FBG sensors.

If the optical fibers are deformed due to intrusion of the intruder, the wavelength variation and the wavelength intensity of the optical fibers are also changed, and the measurement system detects the changed wavelength variation and the wavelength intensity of the optical fibers. In addition, if the intruder breaks through the optical fibers formed between the FBG sensors, since the measurement system does not detect the wavelength of the FBG sensors aligned rearward of the cut-off area, the measurement system detects intrusion of the intruder based on the number of the FBG sensors that send wavelength signals to the measurement system.

(c) The wavelength variation and the wavelength intensity of the optical fibers and the number of FBG sensors measured by the measurement system are compared with reference values, thereby determining intrusion of the intruder.

FIG. 4 is a view illustrating an installation method for optical fibers according to the present invention.

As shown in FIG. 4, the optical fiber 50 is installed together with a circular-shaped path 120 so as to precisely and easily detect intrusion of the intruder. In addition, a cylindrical link 130 is provided adjacent to the circular-shaped path 120 so as to receive the optical fiber 50 therein. Preferably, the optical fiber 50 is inserted into the cylindrical link 130. The cylindrical link 130 keeps roundness of the optical fiber 50.

If the diameter of the circular-shaped path 120 is 25 mm or less, loss of light intensity may greatly increase due to the characteristics of the optical fiber 50. Accordingly, if the intruder touches the optical fiber 50, the diameter of the circular-shaped path 120 is reduced, so that the loss of light intensity may greatly increase. Thus, the attenuation rate is also increased so that the measurement system can easily detect intrusion of the intruder even if the optical fiber 50 is slightly deformed.

### INDUSTRIAL APPLICABILITY

As described above, according to the apparatus and the method for detecting intrusion by using the FBG sensors of the present invention, the intrusion protection system may not malfunction even if the intrusion protection system is subject to the severe natural phenomenon such as rain, wind and snow. In addition, since the measurement system measures the intrinsic reflective wavelength of the FBG sensors, the measurement speed is improved. Furthermore, since the present invention makes use of the optical switch, the system establishment cost can be reduced and the intrusion detection area can be enlarged by 10 times as compared with the conventional intrusion detection area. In addition, the present invention makes use of the optical distributor, so that a plurality of independent intrusion detection areas can be formed and influence derived from the cut-off of the optical fibers can be minimized. In addition, the present invention can detect the wavelength variation, wavelength intensity and disconnection of optical fibers by using the FBG sensors, so the present invention can precisely and reliably detect intrusion of the intruder together with various application tools. The present invention can provide an intrusion detection system having a light weight and can facilitate installation and repair and maintenance work for the intrusion detection system. The intrusion detection system according to the present invention has superior functional flexibility, so that the intrusion detection system employing the FBG sensors can be used in various fields, such as the intrusion inspection, safety analysis for a structure, fire detection, temperature detection, water level detection, and pressure detection.

It will be apparent to those skilled in the art that various modifications and variations can be made in the present invention. Thus, it is intended that the present invention covers the modifications and variations thereof within the scope of the appended claims.

1. An apparatus for detecting intrusion, the apparatus comprising:
a measurement system;
an optical fiber for transmitting and detecting optical signals; and
a plurality of fiber Bragg grating (FBG) sensors installed in intrusion detection areas together with the optical fiber and representing reflective wavelengths different from each other.

2. The apparatus as claimed in claim 1, further comprising an optical distributor installed between the measurement system and the FBG sensors in order to divide the intrusion detection area into a plurality of intrusion detection areas.

3. The apparatus as claimed in claim 1, further comprising an optical switch installed between the measurement system and the FBG sensors so as to form at least one independent intrusion detection channel in such a manner that sensors having reflective wavelengths identical to those of other channels are used in new independent intrusion detection areas.

4. The apparatus as claimed in claim 1, wherein the optical fiber has a circular-shape path.

5. The apparatus as claimed in claim 1, wherein the optical fiber connecting the FBG sensors with each other is installed in the intrusion detection area in a zigzag pattern in such a manner that an intruder does not pass through the optical fiber without cutting off the optical fiber.

6. The apparatus as claimed in claim 1, wherein the optical fiber connecting the FBG sensors with each other is installed in the intrusion detection area in a form of a net in such a manner that an intruder does not pass through the optical fiber without cutting off the optical fiber.

7. The apparatus as claimed in claim 5, wherein an attachment, such as a needle, is buried below the intrusion detection area, and the optical fiber is connected to the attachment.

8. The apparatus as claimed in claim 6, wherein an attachment, such as a needle, is buried below the intrusion detection area, and the optical fiber is connected to the attachment.

9. The apparatus as claimed in claim 1, wherein FBG sensors aligned adjacent to the measurement system have reflectivity lower than reflectivity of FBG sensors aligned remote from the measurement system.

10. A method for detection intrusion by using fiber Bragg grating (FBG) sensors, the method comprising the steps of:
installing an optical fiber and the FBG sensors in predetermined intrusion areas;
continuously measuring wavelength variation or wavelength intensity of the optical fiber by using a measurement system; and
comparing the measured wavelength variation or measured wavelength intensity of the optical fiber with a reference value, thereby determining intrusion of an intruder.

11. A method for detection intrusion by using fiber Bragg grating (FBG) sensors, the method comprising the steps of:
installing an optical fiber and the FBG sensors in predetermined intrusion areas;
continuously measuring a number of the FBG sensors by using a measurement system; and
comparing the measured number of the FBG sensors with a reference value, thereby determining intrusion of an intruder.
